(19) United States
(12) Patent Application Publication
(10) Pub. No.: US 2025/0122394 A1
(43) Pub. Date: Apr. 17, 2025

(54) LUMINESCENT PRINTING INK FOR SECURITY PRINTING, ITEM HAVING LUMINESCENT FEATURE, AND PRODUCTION METHOD

(71) Applicant: GIESECKE+DEVRIENT CURRENCY TECHNOLOGY GMBH, Munchen (DE)

(72) Inventors: Anika STRITT, Munchen (DE); Verena ENGELHARDT, Munchen (DE)

(21) Appl. No.: 18/293,866

(22) PCT Filed: Jul. 27, 2022
(86) PCT No.: PCT/EP2022/025355

§ 371 Date: Jan. 31, 2024

(30) Foreign Application Priority Data
Aug. 3, 2021 (DE) 10 2021 003 985.8

(51) Int. Cl. C09D 11/50; B42D 25/29; B42D 25/382; B42D 25/387; C09D 11/037; C09K 11/02; C09K 11/58; G07D 7/1205

(52) U.S. Cl. CPC C09D 11/50; B42D 25/382; B42D 25/387; C09D 11/037; C09K 11/025; C09K 11/584; G07D 7/1205; B42D 25/29; G07D 2207/00

(57) ABSTRACT

A luminescent printing ink for security printing includes a fluorescent substance and a phosphorescent substance which each luminesce in the visible spectral range when excited with non-visible excitation light. The printing ink contains one or more capsule luminescent pigment varieties, each of which has a core, a shell encapsulating the core and a luminescent substance present in the core. The fluorescent substance and the phosphorescent substance are each present as a luminescent substance in the core of one or more of the capsule luminescent pigment varieties so that the capsule luminescent pigments form fluorescent capsule luminescent pigments and/or phosphorescent capsule luminescent pigments. The luminescences of the fluorescent and the phosphorescent capsule luminescence pigments have the same light-fastness and the same chemical stability, and their luminescences visually produce a substantially matching colour impression.

### FIELD OF THE DISCLOSURE

The invention relates to a luminescent printing ink for security printing and to a method of producing such a printing ink. The invention also relates to an article, especially a document of value, a security paper or a product packaging, having such a printed-on luminescent feature comprising such a luminescent printing ink, and to a corresponding production method.

### BACKGROUND

In order to safeguard documents of value, for instance banknotes or bank cards, of product packaging and of other products to be safeguarded, for instance medicaments, luminescent features have been used for many years, which are printed onto the document of value, and the presence of which can be used to verify authenticity by irradiation with a suitable light source. Luminescent substances, which are normally invisible to the eye in daylight, are excited by UV radiation of suitable wavelength, and the presence thereof is verified by the luminescence light. Luminescence can be tested visually here; for example, the presence of a luminescence emission with a defined color and agreement with a defined spatial pattern can be verified by an observer. Machine testing of authenticity is also possible, where the luminescence emission is recorded with an optoelectronic detector and the measurement signal is tested for defined characteristic properties in order to obtain an indication of the authenticity of the document of value.

Inorganic phosphors are often used for machine-detectable luminescence features. Fluorescent substances are generally less suitable for machine authenticity testing because of their short decay times, since many impurities, for instance optical brighteners from domestic laundry detergents, which are often found on banknotes in circulation, fluoresce themselves, and reliable machine detection of a fluorescent security feature is therefore made more difficult by such background fluorescences. Therefore, phosphorescent substances are usually used for machine-detectable security features, and these emit light with a characteristic decay time even after the excitation radiation has been switched off, such that luminescence can be readily distinguished from any background fluorescences.

The inorganic phosphors mentioned generally have good to very good chemical stabilities and good lightfastness, but also have a number of disadvantages. For instance, inorganic phosphors have much shorter luminescence intensities compared to the organic luminescent substances typically used for visual verification. This requires a relatively high loading of a printing ink with the phosphorescence pigments in order still to obtain sufficient visual luminescence intensity for visual testing. As a result, however, the laden printing ink can be printed only with difficulty; for example, it is not possible to print intricate patterns. Moreover, inorganic phosphors have high mechanical hardness that can additionally lead to mechanical abrasion and wear in the printing machines. The high density of inorganic phosphors can also have the effect that the printing inks laden therewith separate in the ink fountain during long printing operations or after prolonged storage.

As an alternative to inorganic phosphorescent substances, metal-organic phosphorescent substances are known. These are of better suitability than inorganic phosphors for use in standard printing inks, but have lower chemical stability and are sensitive, for example, toward acids and bases. This disadvantage can be countered by the use of capsule luminescence pigments where the phosphorescent substances are enclosed in the core and are encased by a featureless shell. This increases the chemical stability of the luminescent substances, but it is only possible to distribute a limited amount of luminescent substance in the core, and so encapsulated metal-organic phosphorescence pigments have only a low luminescence intensity. Even though this low luminescence intensity is sufficient for machine authenticity testing, phosphorescent capsule luminescence pigments are often unsuitable for visual verification.

### SUMMARY

In the light of this, it is an object of the invention to overcome the disadvantages of the prior art and especially to provide a luminescent printing ink for security printing that can be reliably tested for authenticity either visually or by machine. The invention is also to specify a production method for such a printing ink, and an article having a luminescence feature printed on with such a printing ink and a corresponding production method are to be provided.

According to the invention, a luminescent printing ink for security printing contains a fluorescent substance and a phosphorescent substance, each of which luminesces in the visible spectral region on excitation with nonvisible excitation light.

This printing ink contains one or more capsule luminescence pigment types, each of which has a core, a shell encapsulating the core, and a luminescent substance present within the core.

The fluorescent substance and the phosphorescent substance are each present as luminescent substance within the core of one or more of the capsule luminescence pigment types, such that the capsule luminescence pigments form fluorescent and/or phosphorescent capsule luminescence pigments having fluorescence and phosphorescence.

The fluorescence and phosphorescence of the capsule luminescence pigments have the same lightfastness and the same chemical stability, and they create an essentially corresponding color impression in visual terms.

One capsule luminescence pigment type refers here to capsule luminescence pigments each having the same core-shell structure and the same luminescent substance present within the core. For example, the abovementioned fluorescent capsule luminescence pigments and the phosphorescent capsule luminescence pigments each form one capsule luminescence pigment type. It is also possible for capsule luminescence pigments wherein both a fluorescent substance and a phosphorescent substance are present in the core to form one capsule luminescence pigment type.

Useful nonvisible excitation light is advantageously UV light, especially in the UV-A region, for example with a peak illuminance at a wavelength of 365 nm. In addition, IR-excitable luminescent substances are also known, especially what are called up-converters, which can be excited by nonvisible excitation light in the infrared spectral region and then show emission in the visible spectral region.

The UV spectral region, for the purposes of the present description, extends from 10 to 380 nm, especially from 200 to 380 nm, the visible spectral region from 380 to 780 nm, and the IR spectral region from 780 nm to 30 μm, especially from 780 to 3000 nm. The figures are each based on the peak of a spectrum.

Fluorescent substances and phosphorescent substances are both luminescent substances, but differ in their luminescence decay time. Luminescent substances having a decay time of 10 μs or more are referred to in the context of this description as phosphorescent substances, whereas luminescent substances that have a decay time of 1 μs or less are referred to as fluorescent substances. Luminescence with a decay time of 10 μs or more is referred to in the context of this description as phosphorescence, and luminescence with a decay time of 1 μs or less as fluorescence.

The luminescent printing ink must include at least one fluorescent substance and at least one phosphorescent substance, but it will be apparent that it may also include two or more fluorescent substances and/or two or more phosphorescent substances. A fluorescent substance or phosphorescent substance may also exist as a mixture of two or more fluorescent substances or phosphorescent substances.

The phosphorescent substances of the present invention advantageously have a decay time of at least 100 μs, more preferably between 250 μs and 5 ms. In this time window, exact detection of the decay characteristics of a marking printed with the luminescent printing ink is also possible on high-speed banknote processing machines. A further advantage of phosphorescent substances is that the characteristic luminescence decay time of a phosphorescent substance used can be utilized as a further security feature.

The decay time of the fluorescent substances of the present invention is advantageously even below 0.1 μs and may extend down to the nano- or even picosecond range.

The phosphorescent substance in the luminescent printing ink advantageously has a greater luminescence decay time than the fluorescent substance at least by a factor of 10, preferably even by a factor of 50 or even 100.

The at least one phosphorescent substance is advantageously an organic or metal-organic phosphorescent substance, preferably a metal-organic fluorescent substance having Ir, Pt, Zn, Cu, Eu, Tb, Dy, Gd, or Sm as the central atom, more preferably a lanthanoid complex having Eu, Tb, Dy, Gd, or Sm as the central atom, and most preferably having Eu or Tb as the central atom.

The phosphorescent substance is preferably chosen such that it is excitable with UV radiation, preferably in the UV-A region, more preferably with radiation having a peak illuminance at 365 nm, and emits in the visible spectral region. The proportion by mass of the phosphorescent substance in the core of the capsule luminescence pigments is advantageously between 0.1% and 30%, preferably between 5% and 25%, where the percentages are based on weight.

In the case of a phosphorescent substance content above 30%, there is the risk that the phosphorescent substance will disrupt the crosslinking in the formation of the core polymer or of the polymer of the shell, such that the shell has cracks, for example, and hence the protective function of the shell can be lost. By virtue of the maximum phosphorescent substance content of 30%, however, the capsule luminescence pigment appears to have relatively weak luminescence under UV light, even though the phosphorescence intensity is sufficient for machine readability.

This problem is overcome in accordance with the invention by the combination of the phosphorescent substance with a fluorescent substance or with fluorescent capsule luminescence pigments having an essentially corresponding color impression, since the fluorescent substance can substantially increase visual brightness.

The lower chemical stability of the metal-organic phosphorescent substances addressed at the outset is overcome in the context of present invention by the use of capsule luminescence pigments where the luminescent substance is enclosed in the core and is encased by a featureless shell. This makes it possible to increase the chemical stability of the luminescent substances and to achieve good incorporability into the printing ink. Because of their relatively low density, the capsule luminescence pigments of the invention do not separate from the printing inks laden therewith in the ink fountain during long printing operations and remain homogeneously dispersed in the printing ink of the invention. The low hardness thereof enables a long lifetime of the printing plates. The printing ink itself is also suitable for attractive intricate print designs, for example a high-resolution screen print. While, conventionally, the limited amount of phosphorescent substance that can be distributed within the core of a capsule luminescence pigment usually does not permit visual verification because of the low luminescence intensity, the inventive combination with a fluorescent substance of the same color enables high visual brightness of luminescence in spite of the use of encapsulated phosphorescent substances.

The at least one fluorescent substance is preferably one or more organic or metal-organic fluorescent substances. The fluorescent substance is preferably chosen such that it is excitable under irradiation with UV radiation, preferably in the UVA region, more preferably with radiation having a peak illuminance at 365 nm, and emits in the visible spectral region. Suitable organic fluorescent substances are, for example, perylene derivatives, benzoxazinone derivatives, oxinate derivatives, benzothiazone derivatives, anthranilic acid derivatives, aldazine derivatives and salicylic acid derivatives.

More preferably, the fluorescent substance and the phosphorescent substance are matched to one another such that they are excitable with the same nonvisible excitation radiation.

By virtue of the inventive combination of two capsule luminescence pigment types, the luminescent printing ink, in spite of low visual brightness of the machine-readable phosphorescent capsule luminescence pigments, simultaneously achieves high visual brightness. Because of the essentially corresponding color impression, the effects of the two luminescences are amplified visually. The combination additionally offers the option of adjusting the intensity of the visual and machine-readable luminescence in a controlled manner, especially independently, via the mixing ratio of the two luminescent substances and hence matching it to an intended use.

In an advantageous configuration, the luminescence spectra of the fluorescent substance and of the phosphorescent substance are different in spite of the essentially corresponding visual color impression. The presence of different luminescence spectra with essentially a corresponding visual color impression is known from the color teaching of metamerism and is explained by the physiological construction of the color receptors in the eye, such that it is impossible to conclude the composition of the color stimulus (here: the luminescence spectrum) from the color impression. The different luminescence spectra may serve as a further machine-readable authenticity feature since the luminescence emission measured, because of the different decay times of the luminescent substances, then has different spectral distribution depending on the time of measurement. In the case of measurement during the duration of nonvisible excitation, both the fluorescent substance and the phosphorescent substance contribute to emission; the total emission constitutes a weighted addition of the two luminescence spectra. In the case of a measurement after the end of excitation during the decay time of the phosphorescent substance, by contrast, only the phosphorescent substance still contributes to emission, such that the total emission shows the spectrum of the phosphorescent substance alone.

The capsule luminescence pigments in the printing ink advantageously each have a polymer core with at least one luminescent substance dissolved or dispersed therein, and a shell of a second polymer. Suitable polymers for core and shell are especially selected according to document WO 2017/080654 A1, the disclosure of which in this respect is incorporated into the present application.

Such a core/shell structure ensures high chemical stability of the luminescence of the encapsulated luminescence pigments to outside influences. Outside influences here are understood to mean in particular air humidity, a watery environment, perspiration, greases, detergents, solvents or chemical compounds such as alkalis, acids, alcohols or acetone. The core and the shell of the different capsule luminescence pigment types preferably each consist of the same materials, such that these differ merely by the luminescent substance present in the core. In an advantageous variant, the core consists of a first polymer and the shell of a second polymer that differs from the core polymer in at least one monomer.

Particularly advantageously, the two capsule luminescence pigment types in the luminescent printing ink essentially do not differ in their chemical and physical properties. This can be achieved by virtue of a mutually matched choice of materials for capsule core and capsule shell; for example, in the simplest case, it is possible to choose the same materials in each case for the core and the shell of different capsule luminescence pigment types, as described above. It is especially important here that the fluorescence and phosphorescence have the same lightfastness, i.e. do not differ in their stability to irradiation with daylight. There could otherwise be discrepancies in an authenticity test, since a luminescence feature printed with the printing ink can then, for example, still luminesce sufficiently but be rejected by a banknote testing device because of too low an intensity, since the phosphorescent component has already degraded.

Lightfastness in the present description is defined as described in document WO 2017/080654 A1, where the luminescence of the capsule luminescence pigments of a luminescent printing ink of the invention can especially be tested for lightfastness by the test method described therein. By this method, lightfastness is equal especially when the intensities of fluorescence and phosphorescence of the capsule luminescence pigments normalized to the starting value, each at 1 to 4 on the wool scale according to test method B of WO 2017/080654 A1, differ from one another by fewer than 20 percentage points, preferably by fewer than 10 percentage points. This makes it possible for the fluorescence and phosphorescence of the printing ink not to degrade at different speeds under daylight illumination.

The encapsulation of the two luminescent substances can also ensure that the fluorescence and phosphorescence do not differ in their chemical stability. This offers a significant advantage over an alternative procedure in which fluorescent and phosphorescent substances are mixed without a shell. Without encapsulation, for instance after a washing machine cycle, there can be loss or bleaching of one of the pigments, such that, for example, machine readability could be lost without this being visually apparent. It would also be possible for the visible component to be leached out as a result of treatment of the document of value with a solvent, while the machine-readable component is retained. The security feature would then only be apparent with difficulty, if at all, to the normal user and would thus have no benefit to society.

In the context of this invention, essentially equally high chemical stability of fluorescence and phosphorescence is understood to mean that the intensity of fluorescence that remains after contact with a chemical, measured for example during a continuous excitation illumination (see above), and phosphorescence, measured for example 10 μs after the end of excitation (see below), of a print proof is higher in each case than 80% of the starting intensity, especially after exposure for 5 minutes to toluene, ethyl acetate, hydrochloric acid (5%), sodium hydroxide solution (2%), sodium hypochlorite solution (5% active chlorine) and acetone. For details of the test method, reference is made to test method A5 of WO 2017/080654 A1.

If the printing ink contains two or more capsule luminescence pigment types, these advantageously have the same grain size, where the D99 of the capsule luminescence pigments is advantageously less than 25 μm, preferably even less than 12 μm, especially less than 6 μm.

Equal grain size here means a maximum variance of the D99 of the capsule luminescence pigments of 20% or less, preferably of 10% or less.

Because of the advantageous identity of the physical and chemical properties of the capsule luminescence pigment types, these can be mixed directly in a security printing ink. Since the pigments have the same printing properties, the mixture cannot separate again in the printing ink because of the equal density of the pigments. The visual and machine-readable impressions also do not change independently of one another as a result of outside effects, such that, even in the case of a change in the overall color impression with time, the color impressions created by the fluorescent substance and the phosphorescent substance remain the same relative to one another. It is therefore not possible for an observer to tell without the aid of optical devices, for example a spectrometer, that the printing ink contains not just a single luminescence pigment but in fact a mixture of two luminescence pigments of the same color. This makes it much more difficult to recreate a luminescence feature generated with the printing ink.

The fluorescence and phosphorescence of the capsule luminescence pigments create an essentially corresponding color impression in visual terms. Two luminescences in the context of the present invention have an essentially corresponding color impression especially when the standard color value components (x₁, y₁) and (x₂, y₂) of the luminescences lie in two color regions that adjoin one another along a line or a vertex, preferably in the same color region of the CIE standard color space (CIE-1931), as defined in the article Kenneth L. Kelly, “Color Designations for Lights”, Journal of the Optical Society of America, vol. 33 (1943) pp. 627-632. These color regions are also referred to hereinafter as Kelly color regions for short.

By way of illustration, FIG. 4 shows the CIE-1931 color diagram in the coordinate system of the standard color components x and y, with the Kelly color regions No. 1 to No. 23 drawn in. The color impression of color region No. 23 is referred to, for example, as “green” by Kelly, and the color impression of the adjoining color regions No. 2 and No. 22 as “yellowish green” and “bluish green”, etc. The specific names of the color regions are immaterial in respect of the present invention; they serve merely for brief naming of the different color regions.

In an advantageous configuration, the phosphorescent substance and the fluorescent substance have each been introduced separately into the cores of different capsule luminescence pigments. The printing ink therefore contains a first, fluorescent capsule luminescence pigment type, the cores of which contain only fluorescent substances, but no phosphorescent substances, and a second, phosphorescent capsule luminescence pigment type, the cores of which contain only phosphorescent substances, but no fluorescent substances. This configuration has the advantage that the ratio of phosphorescent substances and fluorescent substances in the printing ink can readily be adjusted individually and hence the relative intensities of fluorescence and phosphorescence can be adjusted as desired.

In another, likewise advantageous configuration, the phosphorescent substance and the fluorescent substance are collectively introduced into the cores of capsule luminescence pigments, such that the printing ink contains a fluorescent and simultaneously phosphorescent capsule luminescence pigment type, the cores of which contain both fluorescent substances and phosphorescent substances. In this configuration, the same chemical stability and printability is automatically assured, and both luminescent substances are always distributed homogeneously in the printing ink.

A combination of the two configurations is also possible, such that, for example, a first capsule luminescence pigment type wherein the cores contain both phosphorescent substances and fluorescent substances and a second capsule luminescence pigment type wherein the cores contain only fluorescent substances or only phosphorescent substances are present in a printing ink. A combination of all three types is also possible.

The fluorescent substance of the capsule luminescence pigments is especially present in the printing ink in a concentration that permits visual testing of luminescence. Preferably, the luminescence brightness of the printing ink is at least 100%, preferably at least 150%, especially at least 200%, of the reference brightness of a green-luminescing printing ink with a ZnS:Cu standard security pigment with 10% by weight of pigmentation at the same ink weight per unit area. Further advantageous details of the standard security pigment and of a preferred definition of the reference sample are specified further down. A measure used for brightness is advantageously the spectral integral over the luminescence spectrum during excitation multiplied by the visual sensitivity curve of the human eye.

The phosphorescent substance of the capsule luminescence pigments is present in the printing ink especially in a concentration that permits machine testing of luminescence in a banknote processing machine. Preferably, the phosphorescence intensity of the printing ink is at least 100%, preferably at least 120%, especially at least 130%, of the reference intensity of a green-luminescing printing ink with a ZnS:Cu standard security pigment with 10% by weight of pigmentation at the same ink weight per unit area. Further advantageous details of the standard security pigment and of a preferred definition of the reference sample are specified further down.

A measure used for phosphorescence intensity is advantageously the spectral integral over the luminescence spectrum after the excitation illumination has been switched off, for example 10 μs after the excitation illumination has been switched off.

In all configurations, the concentration of a luminescent substance in the printing ink is the product of the concentration of the luminescent substance in the corresponding capsule luminescence pigment and the concentration of the corresponding capsule luminescence pigments in the printing ink.

The invention also relates to methods of producing a luminescent printing ink of the type described above for security printing. In a first advantageous variant of the method,
B) a fluorescent substance and a phosphorescent substance are provided, each of which luminesce in the visible spectral region on excitation with nonvisible excitation light, and the luminescences of which create an essentially corresponding color impression in visual terms and have equal lightfastness,
E1) the fluorescent substance is introduced into the core of first capsule luminescence pigments and the phosphorescent substance is introduced into the core of second capsule luminescence pigments, where the capsule luminescence pigments each have a core and a shell that encapsulates the core, and the materials of core and shell of the capsule luminescence pigments are chosen such that the luminescences of the first and second capsule luminescence pigments have equal chemical stability, and
D) the first and second capsule luminescence pigments with the luminescent substances introduced into the core are introduced into a printing ink.

In another, likewise advantageous variant of the method,
B) a fluorescent substance and a phosphorescent substance are provided, each of which luminesce in the visible spectral region on excitation with nonvisible excitation light, and the luminescences of which create an essentially corresponding color impression in visual terms and have equal lightfastness,
E2) the fluorescent substance and the phosphorescent substance are collectively introduced into the core of third capsule luminescence pigments having a core and a shell that encapsulates the core, and
D) the third capsule luminescence pigments with the luminescent substances introduced into the core are introduced into a printing ink.

The invention further includes an article, especially a document of value, a security paper, a security element or a product packaging, comprising a printed-on luminescence feature comprising at least one luminescent printing ink of the type described.

The invention finally also includes a method of producing an article of the type described, in which a luminescence feature is printed onto the article with at least one luminescent printing ink of the type described.

### BRIEF DESCRIPTION OF THE DRAWINGS

Further working examples and advantages of the invention are elucidated hereinafter with reference to the figures, where reproduction to scale and in proportion has been dispensed with in the representation in order to increase clarity.

The figures show:

FIG. 1 a schematic diagram of a banknote with a machine-readable security element printed on the banknote paper,

FIG. 2 the security element from FIG. 1 in a schematic cross-sectional view,

FIG. 3, including FIGS. 3(a) and 3(b), 3(a) a security element in which phosphorescent substances and fluorescent substances are incorporated collectively into the core of capsule luminescence pigments, and 3(b) a security element comprising first, mixed capsule luminescence pigments and comprising second, fluorescent capsule luminescence pigments.

FIG. 4 the CIE-1931 color diagram in the coordinate system of the standard color value components x and y, with Kelly color regions No. 1 to No. 23 drawn in,

FIG. 5 in a representation like FIG. 4, in the CIE color diagram, the color loci of proofs A, B and AₓB_{y}(color regions No. 2, 23) and of proofs E, F and E₁F₂ (color regions No. 9, 12),

FIG. 6 a detail from a banknote with a paper substrate and a luminescent security element of the invention that has been printed on the paper substrate, and

FIG. 7 a security element on a paper substrate of a document of value in a further working example of the invention.

### DETAILED DESCRIPTION OF VARIOUS EMBODIMENTS

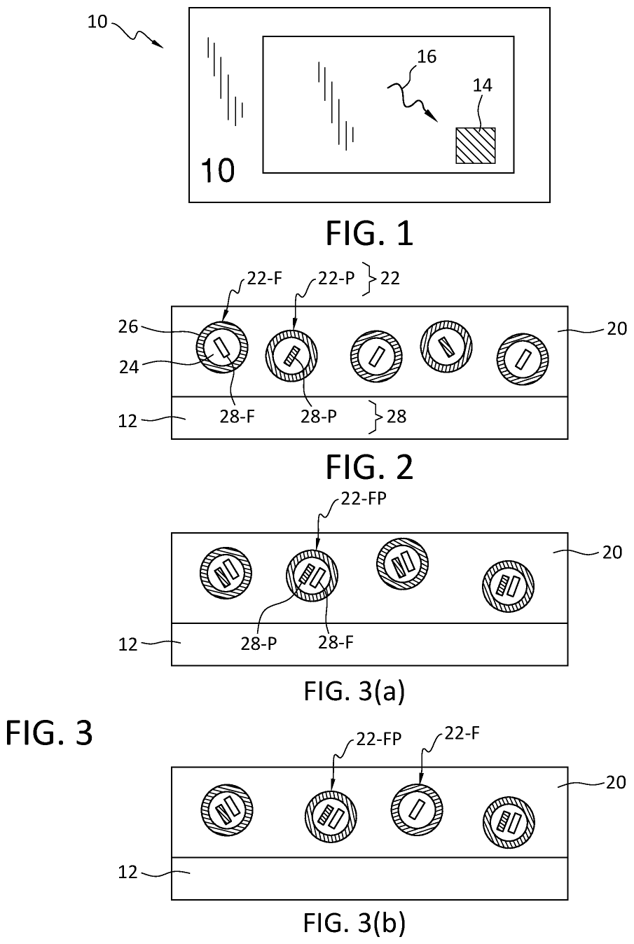

The invention will now be elucidated using the example of banknotes and other documents of value with printed-on luminescence features. FIG. 1 in this regard shows a schematic diagram of a banknote 10 with a machine-readable security element 14 printed on the banknote paper 12. The security element 14 is a luminescence feature which is invisible under normal illumination with daylight and which luminesces in the visible spectral region on irradiation with nonvisible excitation light, for example UV light 16.

As illustrated by the schematic cross-sectional diagram of FIG. 2, the security element 14 is printed onto the banknote paper 12 with a luminescent security printing ink 20 containing a combination of two different capsule luminescence pigment types 22-F, 22-P. For easier elucidation, the security element 14 is shown as a homogeneous surface, but it will be apparent that luminescence markings in practice usually take the form of a spatial pattern of multiple area regions with possibly different luminescence colors, for example in the form of a halftone print. In this case, a portion or even the entirety of the luminescence marking may have been printed with security printing inks of the invention.

The capsule luminescence pigments 22 of the security printing ink 20 each contain a core 24 of a first polymer with a luminescent substance 28 dissolved or dispersed therein and a shell 26 of a second polymer that encapsulates the core. Suitable polymers are advantageously chosen according to the teaching of document WO 2017/080654 A1. Such a core/shell structure ensures high chemical stability of the luminescence of the encapsulated capsule luminescence pigments with respect to outside influences.

The core 24 and the shell 26 of the different capsule luminescence pigment types 22 preferably each consist of the same materials, except that a fluorescent substance 28-F has been introduced into the core in the first capsule luminescence pigment type 22-F, while a phosphorescent substance 28-P has been introduced into the core in the second capsule luminescence pigment type 22-P. The two capsule luminescence pigment types 22-F, 22-P therefore have essentially the same physical and chemical properties, but differ by the decay times of the luminescent substances present in the core.

In spite of their different decay characteristics, the fluorescent substance 28-F and the phosphorescent substance 28-P are chosen such that the fluorescence and phosphorescence, and hence the two capsule luminescence pigment types 22-F, 22-P, generate an essentially corresponding color impression in luminescence in visual terms. The exact luminescence spectra of the two luminescent substances 28 may quite possibly differ; what is essential is the visual correspondence of the color impression perceived by the eye.

By virtue of the embedding of the luminescent substances 28 in core-shell particles wherein the cores and shells are each formed from the same materials, the capsule luminescence pigment types 22-F, 22-P formed, and hence the fluorescence and phosphorescence, have the same chemical stability and the same lightfastness, i.e. the same stability under irradiation with daylight. These equal stabilities are important since the security feature 14 is subjected to various environmental influences, such as sunlight, perspiration, detergents or solvents, in the circulation of the banknote 10. Because of the equal lightfastness, the color impressions of the fluorescence and phosphorescence do not only correspond to one another initially, but the correspondence is maintained during the lifetime of the banknote 10 even under prolonged insolation.

By virtue of its particular design, the security element 14 can be tested either visually or by machine, and is highly forgeryproof. The phosphorescent substance 28-P of the security element 14 enables reliable machine detection, while the fluorescent substance 28-F of corresponding color ensures high visual brightness of luminescence and hence enables reliable visual testing. By virtue of the equal lightfastness and chemical stability of the luminescence of the two capsule luminescence pigment types 22-P, 22-F, it is additionally assured that the two types will not degrade at different speeds during the lifetime of the banknote 10, but will behave like a single luminescence pigment.

The schematic diagram in FIG. 2 shows, in the core of the pigments 22, solely a phosphorescent substance 28-P or a fluorescent substance 28-F, but it will be apparent that it is generally also possible for two or more phosphorescent substances or fluorescent substances to be present in the respective core. However, in the working example according to FIG. 2, each capsule luminescence pigment 22 contains either solely phosphorescent substances or solely fluorescent substances. The ratio of phosphorescent substances and fluorescent substances in the printing ink can thus be adjusted individually in order to adjust the relative intensities of fluorescence and phosphorescence as desired.

FIG. 3 shows, in 3(a), in schematic form, a configuration in which phosphorescent substances 28-P and fluorescent substances 28-F have been incorporated collectively into the core of the capsule luminescence pigments 22-FP, which thus each comprise both a phosphorescent substance and a fluorescent substance. The security printing ink 20 in FIG. 3(a) therefore contains just a single luminescence pigment type wherein the capsule luminescence pigments 22-FP are both fluorescent and phosphorescent. In this configuration, equal chemical stability of the luminescences and printability are automatically assured, and the two luminescent substances are always distributed homogeneously in the printing ink.

In the further working example in FIG. 3(b), there are two capsule luminescence pigment types in the printing ink 20, namely firstly mixed capsule luminescence pigments 22-FP wherein the cores contain phosphorescent substances 28-P and fluorescent substances 28-F, and secondly fluorescent capsule luminescence pigments 22-F wherein the cores contain solely fluorescent substances 28-F, and which serve to increase visual brightness. Analogously, there are also possible configurations in which the printing ink 20 contains mixed capsule luminescence pigments 22-FP and, in order to improve machine readability, phosphorescent capsule luminescence pigments 22-P, or else configurations in which the printing ink 20 contains mixed capsule luminescence pigments 22-FP, fluorescent capsule luminescence pigments 22-F and phosphorescent capsule luminescence pigments 22-P.

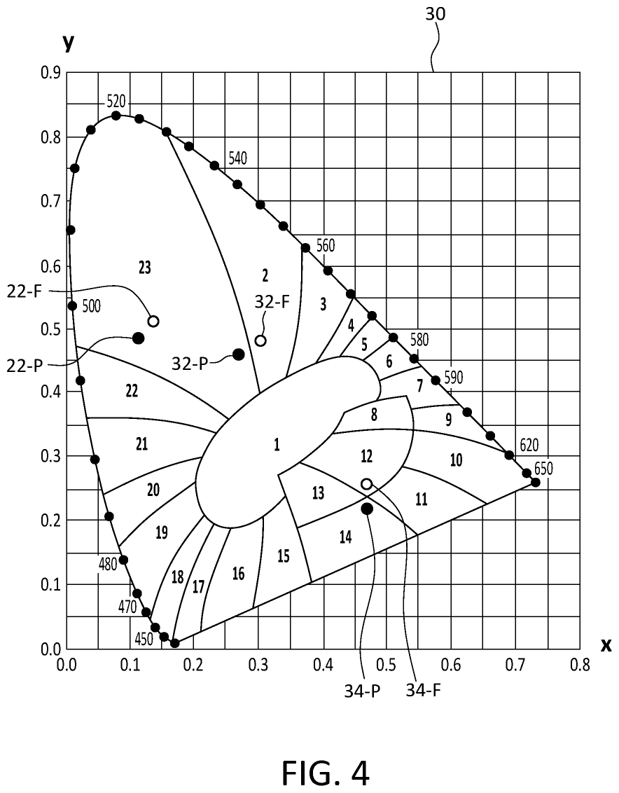

FIG. 4 illustrates the essentially corresponding color impression of the capsule luminescence pigments 22-F, 22-P. The figure shows the CIE-1931 color diagram 30 in the coordinate system of the standard color value components x and y and the Kelly color regions No. 1 to No. 23 that have been drawn in, as defined in the above-cited article Kenneth L. Kelly, “Color Designations for Lights”.

Likewise drawn in are the color loci of the luminescence of the capsule luminescence pigments 22-F and 22-P, both of which lie in the same color region No. 23 (“green”), such that they create a corresponding color impression in visual terms.

Also shown are the color loci of the capsule luminescence pigments of a modification of the luminescent printing ink from FIG. 2, in which the color locus of the fluorescent capsule luminescence pigments 32-F lies in color region No. 2 (“yellowish green”) and the color locus of the phosphorescent capsule luminescence pigments 32-P in color region No. 23 (“green”). Color regions No. 2 and No. 23 join along an edge, such that capsule luminescence pigments 32-P, 32-F, and hence the fluorescence and phosphorescence, create an essentially corresponding color impression in luminescence in visual terms.

In a further luminescent printing ink, the color locus of the fluorescent capsule luminescence pigments 34-F present lies in color region No. 12 (“pink”) and the color locus of the phosphorescent capsule luminescence pigments 34-P present in color region No. 14 (“red-purple”). Color regions No. 12 and No. 14 join at a corner, such that luminescence pigments 34-P, 34-F, and hence also the fluorescence and phosphorescence, create an essentially corresponding color impression in luminescence in visual terms.

The standard color value components (x,y) of a luminescence, for example a fluorescence or phosphorescence, can be determined in accordance with DIN EN ISO 11664:2007 using the steady-state emission spectra of proofs. For measurement, for example, a Horiba FluoroMax-4P spectrometer with the following spectrometer settings is used:

| | |
|---|---|
| Emission wavelength | start 400 nm, end 750 nm, inc 1 nm |
| Emission slit (bandpass) | 1 nm |
| Excitation wavelength | 365 nm |
| Excitation slit (bandpass) | 1 nm |
| Filter | KV389 |

In order to assess visual brightness and machine-readable phosphorescence intensity, a reference substance is used, namely the inorganic phosphorescent substance CD140 from Honeywell. This phosphorescent substance is a green-luminescing standard security pigment (ZnS:Cu) for use in banknote printing. The pigment was incorporated into a printing ink with 10% by weight of pigmentation using a three-roll mill from EXAKT GmbH (model No. 80E, manufactured in 2006) and printed onto security paper (banknote paper) without optical brighteners in order to obtain a reference proof. The inorganic phosphor CD140 has low visual brightness but good machine readability.

In order to assess the visual brightness and machine readability of the printing ink for comparison, it was likewise printed onto security paper with an ink weight per unit area of 1 g/m² in order to obtain print proofs.

In order to assess visual brightness, the reference proof and the sample proof are excited with nonvisible excitation light, especially UV light, and the steady-state luminescence spectrum is measured in each case. For this purpose, for example, it is possible to use a Horiba FluoroMax-4P spectrometer with the following spectrometer settings:

| | |
|---|---|
| Emission wavelength | start 400 nm, end 750 nm, inc 1 nm |
| Emission slit (bandpass) | 1 nm |
| Excitation wavelength | 365 nm |
| Excitation slit (bandpass) | 1 nm |
| Filter | KV389 |

The measured luminescence spectra are multiplied by the spectral sensitivity curve of the human eye and spectrally integrated in order to obtain a measure of visual brightness. The visual brightness of the sample proof is then divided by the visual brightness of the reference proof and hence normalized in order to obtain a relative visual brightness of the sample proof.

In order to assess machine readability, the reference proof and the sample proof are excited with nonvisible excitation light, especially UV light, and the phosphorescence intensity is in each case measured after the excitation has been switched off and spectrally integrated. For the measurement, it is possible to use, for example, a Horiba FluoroMax 4P spectrometer with the following spectrometer settings:

| Emission wavelength | start 400 nm, end 750 nm, inc 1 nm | |
|---|---|---|
| Emission slit (bandpass) | 1 | nm |
| Excitation wavelength | 365 | nm |
| Excitation slit (bandpass) | 5 | nm |
| Time between flashes | 61 | ms |
| Flash count | 10 | ms |
| Initial delay | 0.05 | ms |
| Sample window | 0.25 | ms |

| | |
|---|---|
| Filter | KV389 |

The measured spectrally integrated phosphorescence intensity of the sample proof is then divided by the spectrally integrated phosphorescence intensity of the reference proof and hence normalized in order to obtain a relative phosphorescence intensity of the sample proof. Relative phosphorescence intensity is a measure of machine readability.

There follows a more detailed description of some specific, nonlimiting working examples of luminescent printing inks together with their properties. The chemicals and reagents used for the production of the working examples were sourced from the following companies and used without further purification: 2-amino-4-chlorobenzoic acid (acbs) from TCI, terbium chloride hexahydrate from Sigma-Aldrich, CD396, CD397, CD740, CD748 from Honeywell, and Lumogen Red F305 from BASF.

### Working Example 1

Working example 1 is based on a pigment system composed of a green-fluorescing capsule luminescence pigment and a green-phosphorescing capsule luminescence pigment.

The pigments used were produced in accordance with example 1 of document WO 2017/080656 A1. The green-fluorescing capsule luminescence pigment GF1 consists of a polyurea core with an organic fluorescent substance distributed therein from the class of the quinazoline derivatives (CD 396 from Honeywell), and a melamine-formaldehyde shell.

The green-phosphorescing capsule luminescence pigment GP1 consists of a polyurea core with rare earth metal complex distributed therein (CD 748 from Honeywell) and a melamine-formaldehyde shell. The proportion by mass of each of the two luminescent substances in the core polymer is 20% by weight, based on the core polymer.

Both capsule luminescence pigments are green-luminescing under excitation with UV light with a peak illuminance at 365 nm. If it is said by way of abbreviation hereinafter that these pigments or inks or proofs derived therefrom luminesce, this always means that they luminesce under UV excitation at 365 nm.

### Production of the Printing Inks:

Pure fluorescent ink (A): 120 g of the green-fluorescing pigment GF1 is incorporated into an offset printing ink (Sicpa Holding SA) with the aid of a three-roll mill. The pigmentation level of this ink is 15% by weight.

Pure phosphorescent ink (B): 120 g of the green-phosphorescing pigment GP1 is incorporated into an offset printing ink (Sicpa Holding SA) with the aid of a three-roll mill. The pigmentation level of this ink is 15% by weight.

Mixed inks (AₓB_{y}): The two inks A and B are blended with one another with the aid of a three-roll mill in respective proportions such that the two inks A and B are present in an x:y ratio of 2:1 (A₂B₁), 1:1 (A₁B₁), 1:2 (A₁B₂) or 1:3 (A₁B₃). The resultant offset printing inks luminesce in the green.

The pure inks A, B and the mixed inks AₓB_{y} are printed onto security paper with an ink weight per unit area of 1 g/m², and the proofs are dried at 60° C. for 2 h. The corresponding proofs are referred to hereinafter as proofs A, B and AₓB_{y}.

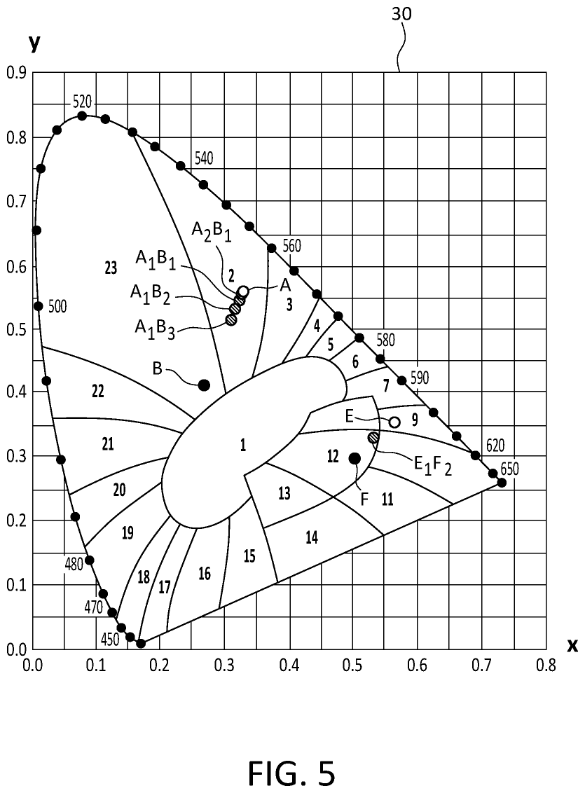

The table below reports the color regions of the CIE standard color space in FIGS. 4 and 5 and the visual brightnesses and phosphorescence intensities of the luminescence emissions of the proofs.

| | Standard color | | Kelly | Visual | |
|---|---|---|---|---|---|
| | values | | color | brightness | Phosphorescence |
| | of emission | | region | vs. | intensity vs. |
| Proof | x | y | No. | reference | reference |
| A | 0.327 | 0.552 | 2 | 686% | 0% |
| B | 0.266 | 0.407 | 23 | 97% | 189% |
| A₂B₁ | 0.326 | 0.550 | 2 | 534% | 69% |
| A₁B₁ | 0.322 | 0.539 | 2 | 388% | 99% |
| A₁B₂ | 0.315 | 0.525 | 2 | 314% | 132% |
| A₁B₃ | 0.309 | 0.509 | 2 | 241% | 143% |

Proof B is visually of about the same brightness as the reference proof, but its phosphorescence intensity at 189% is well above the reference. Mixing with the pure fluorescent ink A improves visual brightness, while machine readability is maintained. The proportion of the pure phosphorescent ink B, or of the phosphorescence pigment, in the mixture should be above 50% in order still to obtain sufficiently high machine readability.

The standard color value components of the two proofs A and B lie in the adjoining Kelly color regions No. 2 and No. 23; they therefore have an essentially corresponding color impression in visual terms. The binary mixtures AₓB_{y} all lie in the same color region No. 2 as fluorescent ink A. FIG. 5 shows, in a diagram like FIG. 4, the color loci of the proofs A (white dot) and B (black dot) and of the proofs AₓB_{y} (hatched dots) in the CIE color diagram 30.

In addition, the proofs A and B, and hence the fluorescence and phosphorescence, also have equal lightfastness of luminescence under solar irradiation. Since the emission spectrum remains constant on aging, the index measured for visual brightness is the spectrally integrated intensity of fluorescence emission. The index used for machine-readable intensity is the spectrally integrated intensity of phosphorescence emission. Both intensities have a similar wool scale progression.

The visual brightness and machine luminescence intensity of a proof is measured quantitatively prior to irradiation, for example by means of a Horiba FluoroMax 4 spectrometer with the abovementioned settings, and normalized to 100%. The proof strip is then subjected to a wool scale test analogously to EN ISO 105-B01:1999, referred to hereinafter as light test, for example in a Q-Lab xenon test chamber (Q-SUN Xe-2-H). The remaining residual intensity of luminescence after attainment of the wool scale points is shown in the table below.

| | Residual | Residual | Difference |
|---|---|---|---|
| | intensity [%] | intensity [%] | [percentage |
| Wool scale | of proof A | of proof B | points] |
| Starting value | 100 | 100 | 0 |
| 1 | 90 | 89 | 1 |
| 2 | 84 | 86 | 2 |
| 3 | 79 | 78 | 1 |
| 4 | 70 | 77 | 7 |

Since the residual intensities of proofs A and B differ by fewer than 10 percentage points at all the wool scale points considered, the fluorescent capsule luminescence pigments (proof A) and the phosphorescent capsule luminescence pigments (proof B), by definition, have equal lightfastness of luminescence.

Correspondingly, the mixed printing inks also show phosphorescence and fluorescence with the same lightfastness, as shown by way of example by the proof A₁B₂:

| | Residual intensity | Residual intensity | Difference |
|---|---|---|---|
| | [%] of A₁B₂ | [%] of A₁B₂ | [percentage |
| Wool scale | fluorescence | phosphorescence | points] |
| Starting value | 100 | 100 | 0 |
| 1 | 90 | 95 | 5 |
| 2 | 86 | 87 | 1 |
| 3 | 80 | 80 | 0 |
| 4 | 70 | 72 | 2 |

The intensities of fluorescence and phosphorescence of the proof A₁B₂, normalized to the starting value, each differ by fewer than 10 percentage points at wool scale 1 to 4, and therefore by definition have the same lightfastness of luminescence. The proof A₁B₂ is therefore a green-luminescing luminescence feature of the invention, where the machine-readable component and the visually visible component age uniformly in the light test. Both visual brightness (314%) and phosphorescence intensity (132%) are significantly increased compared to the reference.

The same applies to the proof A₁B₃, for which phosphorescence and fluorescence likewise have the same lightfastness, and for which both visual brightness (241%) and phosphorescence intensity (143%) are significantly increased compared to the reference.

Because of the described core/shell structure of the pigments, the two luminescent substances in the mixtures AₓB_{y} are also chemically stable to outside influences.

### Working Example 2

Working example 2 is based on a pigment system composed of a green-fluorescing capsule luminescence pigment and a green-phosphorescing capsule luminescence pigment.

The phosphorescing capsule luminescence pigment used was the green-phosphorescing capsule luminescence pigment GP1 from working example 1.

The green-fluorescing capsule luminescence pigment GF2 from working example 2 consists of a polyurea core with an organic fluorescent substance from the class of the benzoxazinone derivatives (CD 397 from Honeywell) distributed therein, and a melamine-formaldehyde shell.

The pure fluorescent ink C was produced analogously to working example 1 with the capsule luminescence pigment GF2 mentioned.

For the production of a mixed ink C₁B₂, 40 g of the green-fluorescing pigment GF2 and 80 g of the green-phosphorescing pigment GP1 were incorporated into an offset printing ink (Sicpa Holding SA) with the aid of a three-roll mill. The pigmentation level of this ink is 15% by weight. The resultant offset printing ink luminesces in the green.

Proofs C and C₁B₂ were produced analogously to working example 1.

The table below reports the color regions of the CIE standard color space from FIGS. 4 and 5, and the visual brightnesses and phosphorescence intensities of the luminescence emissions of the proofs.

| | Standard color | | Kelly | Visual | |
|---|---|---|---|---|---|
| | values of | | color | brightness | Phosphorescence |
| | emission | | region | vs. | intensity vs. |
| Proof | x | y | No. | reference | reference |
| C | 0.357 | 0.547 | 2 | 508% | 0% |
| B | 0.266 | 0.407 | 23 | 97% | 189% |
| C₁B₂ | 0.331 | 0.498 | 2 | 194% | 130% |

The standard color value components of the two proofs C and B, and hence of the fluorescence and phosphorescence, lie in the adjoining Kelly color region Nos. 2 and No. 23; they therefore have an essentially corresponding color impression in visual terms. The binary mixture C₁B₂ lies in the same color region No. 2 as the fluorescent ink C.

In a light test analogous to example 1, proofs B and C show the following residual intensities of luminescence:

| | Residual | Residual | Difference |
|---|---|---|---|
| | intensity [%] | intensity [%] | [percentage |
| Wool scale | of proof C | of proof B | points] |
| Starting value | 100 | 100 | 0 |
| 1 | 93 | 89 | 4 |
| 2 | 91 | 86 | 5 |
| 3 | 88 | 78 | 10 |
| 4 | 83 | 77 | 6 |

Since the residual intensities of proofs C and B differ by 10 percentage points or less at all the wool scale points considered, the fluorescent capsule luminescence pigments (proof C) and the phosphorescent capsule luminescence pigments (proof B) have the same lightfastness by definition.

Correspondingly, the mixed printing ink C₁B₂ also shows phosphorescence and fluorescence with the same lightfastness. The fluorescence and phosphorescence of proof C₁B₂ show the following residual intensities in a light test:

| | Residual | Residual | |
|---|---|---|---|
| | fluorescence | phosphorescence | Difference |
| | intensity [%] | intensity [%] | [percentage |
| Wool scale | of C₁B₂ | of C₁B₂ | points] |
| Starting value | 100 | 100 | 0 |
| 1 | 91 | 87 | 4 |
| 2 | 91 | 84 | 7 |
| 3 | 83 | 79 | 4 |
| 4 | 75 | 76 | 1 |

The intensities of fluorescence and phosphorescence normalized to the starting value each differ on wool scale 1 to 4 by less than 10 percentage points and therefore have the same lightfastness by definition.

The proof C₁B₂ is therefore a further green-luminescing luminescence feature of the invention where both the machine-readable component and the visual component age uniformly in the light test. Both visual brightness (194%) and phosphorescence intensity (130%) are significantly increased compared to the reference. Because of the core/shell structure of the pigments, the two luminescent substances in the mixture C₁B₂ are chemically stable to outside influences.

### Working Example 3

Working example 3 is based on a pigment system composed of a red-fluorescing capsule luminescence pigment and a red-phosphorescing capsule luminescence pigment.

The pigments used were produced analogously to example 1 of document WO 2017/080656 A1. Analogous production in the context of this invention means that the method of encapsulation was adopted, but different dyes were used. The red-fluorescing capsule luminescence pigment RF1 consists of a polyurea core with organic fluorescent substances from the class of the benzoxazinone derivatives (CD 397 from Honeywell) and the perylenes (Lumogen Red F305 from BASF) distributed therein, and a melamine-formaldehyde shell. The proportion by mass of the two luminescent substances in the core polymer is 15% by weight of the benzoxazinone derivative and 1% by weight of the perylenes, based on the core polymer.

The red-phosphorescing capsule luminescence pigment RP1 consists of a polyurea core with rare earth metal complex (CD 740 from Honeywell) distributed therein, and a melamine-formaldehyde shell. The proportion by mass of the luminescent substances in the core polymer is 1% to 20% by weight, based on the core polymer.

The pure fluorescent ink E and the pure phosphorescent ink F were produced analogously to working example 1 with the capsule luminescence pigments specified. The pure fluorescent ink E contains the red-fluorescing pigment RF1, and the pure phosphorescent ink the red-phosphorescing pigment RP1.

For the production of the mixed ink E₁F₂, 40 g of the red-fluorescing pigment RF1 and 80 g of the red-phosphorescing pigment RP1 were incorporated into an offset printing ink (Sicpa Holding SA) with the aid of a three-roll mill. The pigmentation level of this ink is 15% by weight. The resulting offset printing ink luminesces in the red.

Proofs E, F and E₁F₂ were produced analogously to working example 1.

The table below reports the color regions of the CIE standard color space from FIGS. 4 and 5 and the visual brightnesses and phosphorescence intensities of the luminescence emissions of the proofs.

| | | | Kelly | Visual | |
|---|---|---|---|---|---|
| | Standard color | | color | brightness | Phosphorescence |
| | values of emission | | region | vs. | intensity vs. |
| Proof | x | y | No. | reference | reference |
| E | 0.565 | 0.351 | 9 | 272% | 0% |
| F | 0.503 | 0.296 | 12 | 92% | 164% |
| E₁F₂ | 0.534 | 0.329 | 12 | 166% | 121% |

The standard color value components of the two proofs E and F, and hence of the fluorescence and phosphorescence, lie in Kelly color regions No. 9 (“reddish orange”) and No. 12 (“pink”) that adjoin one another at a corner; they therefore have an essentially corresponding color impression in visual terms. The binary mixture E₁F₂ thereof is in the same color region No. 12 as the pure phosphorescent ink F. The color loci of the proofs E (white dot) and F (black dot) and of the proof E₁F₂ (hatched dot) are likewise shown in FIG. 5.

In a light test analogously to working example 1, proofs E and F, and hence the fluorescence and phosphorescence, show the following residual intensities of luminescence:

| | Residual | Residual | Difference |
|---|---|---|---|
| | intensity [%] | intensity [%] | [percentage |
| Wool scale | of proof E | of proof F | points] |
| Starting value | 100 | 100 | 0 |
| 1 | 91 | 87 | 4 |
| 2 | 89 | 85 | 4 |
| 3 | 81 | 82 | 1 |
| 4 | 71 | 80 | 9 |

Since the residual intensities of proofs E and F differ by less than 10 percentage points at all the wool scale points considered, the fluorescent capsule luminescence pigments (proof E) and the phosphorescent capsule luminescence pigments (proof F) have the same lightfastness of luminescence by definition. Correspondingly, the mixed printing inks E₁F₂ also show phosphorescence and fluorescence with the same lightfastness. The fluorescence and phosphorescence of the proof E₁F₂ show the following residual intensities in a light test:

| | Residual | Residual | |
|---|---|---|---|
| | fluorescence | phosphorescence | Difference |
| | intensity [%] | intensity [ % ] | [percentage |
| Wool scale | of E₁F₂ | of E₁F₂ | points] |
| Starting value | 100 | 100 | 0 |
| 1 | 88 | 89 | 1 |
| 2 | 86 | 87 | 1 |
| 3 | 83 | 86 | 3 |
| 4 | 75 | 83 | 8 |

The intensities of fluorescence and phosphorescence normalized to the starting value each differ on wool scale 1 to 4 by less than 10 percentage points and therefore have the same lightfastness by definition.

The proof E₁F₂ is therefore a red-luminescing luminescence feature of the invention where both the machine-readable component and the visual component age uniformly in the light test. Both visual brightness (166%) and phosphorescence intensity (121%) are significantly increased compared to the reference. Because of the core/shell structure of the pigments, the two luminescent substances in the mixture E₁F₂ are chemically stable to outside influences.

### Comparative Example 1

Comparative example 1 relates to a combination of luminescence pigments with different color impression, specifically a green-fluorescing capsule luminescence pigment and a red-phosphorescing capsule luminescence pigment.

The green-fluorescing capsule luminescence pigment used was the pigment GF1 from working example 1, and the red-phosphorescing capsule luminescence pigment used was the pigment RP1 from working example 3.

For the production of the comparative mixed inks AₓF_{y}, printing inks A and F from working examples 1 and 3 respectively were blended with one another in relative proportions with the aid of a three-roll mill such that the two inks A and F are present in a ratio x:y of 1:2 (A₁F₂), 1:3 (A₁F₃) and 1:5 (A₁F₅). The resultant offset printing inks luminesce in the yellow to orange.

The proofs AₓF_{y} were produced analogously to working example 1.

The table below reports the color regions from the CIE standard color space of FIG. 4 and the visual brightnesses and phosphorescence intensities of the luminescence emissions of the proofs.

| | Standard color | | | Phosphorescence |
|---|---|---|---|---|
| | values of emission | | Kelly color | intensity vs. |
| Proof | x | y | region No. | reference |
| A | 0.327 | 0.552 | 2 | 0% |
| F | 0.503 | 0.296 | 12 | 164% |
| A₁F₂ | 0.651 | 0.345 | 3 | 113% |
| A₁F₃ | 0.652 | 0.344 | 3 + 4 border | 126% |
| A₁F₅ | 0.654 | 0.342 | 1 | 149% |

The phosphorescence intensities of the comparative proofs AₓF_{y} are higher than those of the reference. But since the color region No. 2 (“yellowish green”) of proof A, i.e. of the fluorescence, and color region No. 12 (“pink”) of proof F, i.e. of the phosphorescence, do not adjoin, the fluorescence and phosphorescence of the mixed inks do not have a corresponding or essentially corresponding color impression.

Accordingly, the standard color values of the comparative proofs AₓF_{y} are neither in color region No. 2 of proof A nor in color region No. 12 of proof F. The mixture of a green-fluorescing pigment A and a red-phosphorescing pigment F instead gives rise to a printing ink that luminesces in the yellow or orange. Luminescence pigments A and F therefore cannot be mixed with one another in order to obtain a security printing ink of the invention, since, in particular, it is not possible to adjust fluorescence intensity and phosphorescence intensity while retaining the luminescence color impression.

### Comparative Example 2

Comparative example 2 contains a phosphorescent substance having poorer lightfastness of luminescence, where the phosphorescent substance used is a terbium complex with 2-amino-4-chlorobenzoic acid (acbs) as ligand.

The terbium complex with 2-amino-4-chlorobenzoic acid as ligand was synthesized as follows:

7.689 g (0.045 mol) of 2-amino-4-chlorobenzoic acid (acbs) is suspended in 200 ml of water and heated to 60° C. 1.792 g sodium hydroxide (0.045 mol) is added in solid form to the suspension and stirred at 60° C. for 1 h. 5.579 g of terbium chloride hexahydrate (0.015 mmol) is gradually added dropwise to the reaction solution as a solution in 20 ml of water, forming a colorless precipitate. The reaction mixture is stirred at 60° C. for 5 h. Subsequently, the precipitated solids are filtered and washed with water (20 ml). Drying in a drying cabinet at 60° C. left the terbium complex in the form of a pale yellowish powder (10 g, 0.0149 mmol, 99%).

The green-fluorescing capsule luminescence pigment used was the pigment GF1 from working example 1.

The green-phosphorescing capsule luminescence pigment produced was a pigment GP2 analogous to example 1 of document WO 2017/080656A1. Pigment GP2 consists of a polyurea core with the above-described terbium complex distributed therein, and a melamine-formaldehyde shell. The proportion by mass of each of the two luminescent substances in the core polymer is 20% by weight based on the core polymer. Both pigments are green-luminescing.

The pure phosphorescent ink G was produced analogously to working example 1 with the capsule luminescence pigment GP2 mentioned.

For the production of the comparative mixed ink A₁G₁, 40 g of the green-fluorescing pigment GF1 and 40 g of the green-phosphorescing pigment GP2 were incorporated into an offset printing ink (Sicpa Holding SA) with the aid of a three-roll mill. The pigmentation level of this ink is 15% by weight. The resultant offset printing inks luminesce in the green.

Proofs G and A₁G₁ were produced analogously to working example 1.

The table below reports the color regions of the CIE standard color space from FIG. 4 and the visual brightnesses and phosphorescence intensities of the luminescence emissions of the proofs.

| | Standard color | | | Visual | Phosphorescence |
|---|---|---|---|---|---|
| | values of emission | | Kelly color | brightness | intensity vs. |
| Proof | x | y | region No. | vs. reference | reference |
| A | 0.327 | 0.552 | 2 | 686% | 0% |
| G | 0.259 | 0.380 | 23 | 172% | 257% |
| A₁G₁ | 0.3183 | 0.5319 | 2 | 434% | 117% |

The standard color value components of the two proofs A and G, and hence of the fluorescence and phosphorescence, lie in the adjoining Kelly color regions No. 2 and No. 23; they therefore have an essentially corresponding color impression in visual terms. The binary mixture A₁G₁ thereof lies in the same color region No. 2 as the pure fluorescence ink A.

In a light test analogously to working example 1, the proofs A and G, and hence the luminescence and phosphorescence, show the following residual intensities of luminescence:

| | Residual | Residual | Difference |
|---|---|---|---|
| | intensity [%] | intensity [%] | [percentage |
| Wool scale | of proof A | of proof G | points] |
| Starting value | 100 | 100 | 0 |
| 1 | 90 | 66 | 24 |
| 2 | 84 | 58 | 26 |
| 3 | 79 | 45 | 34 |
| 4 | 70 | 32 | 38 |

Since the luminescence intensity of proof G, i.e. of the phosphorescence in particular, drops much more quickly in the light test than that of proof A, i.e. of the fluorescence in particular, there are residual intensities that differ by more than 20 percentage points for wool scale points 1 to 4. The capsule luminescence pigments A and G therefore have different lightfastness of luminescence.

The fluorescence and phosphorescence of the proof A₁G₁ show the following residual intensities in a light test:

| | Residual | Residual | Difference | Visual | Phosphorescence |
|---|---|---|---|---|---|
| | fluorescence | phosphorescence | [percentage | brightness vs. | intensity vs. |
| Wool scale | intensity [%] | intensity [%] | points] | reference | reference |
| Starting value | 100 | 100 | 0 | 434% | 117% |
| 1 | 82 | 70 | 12 | 357% | 79% |
| 2 | 76 | 59 | 17 | 329% | 67% |
| 3 | 69 | 46 | 23 | 296% | 53% |
| 4 | 58 | 35 | 23 | 246% | 39% |

The intensities of fluorescence and phosphorescence normalized to the starting value each differ by more than 20 percentage points for wool scale 3 and 4 and therefore have different lightfastness. In particular, the phosphorescence intensity of proof A₁G₁ drops below that of the reference even at wool scale 1.

In the form of comparative proof A₁G₁, a green-luminescing security feature not in accordance with the invention was obtained. The machine-readable component ages more quickly in the light test than the visual component. The security feature after irradiation with daylight, for example at wool scale 4, is visually still bright enough but is no longer machine-readable and would therefore be rejected by a banknote processing machine.

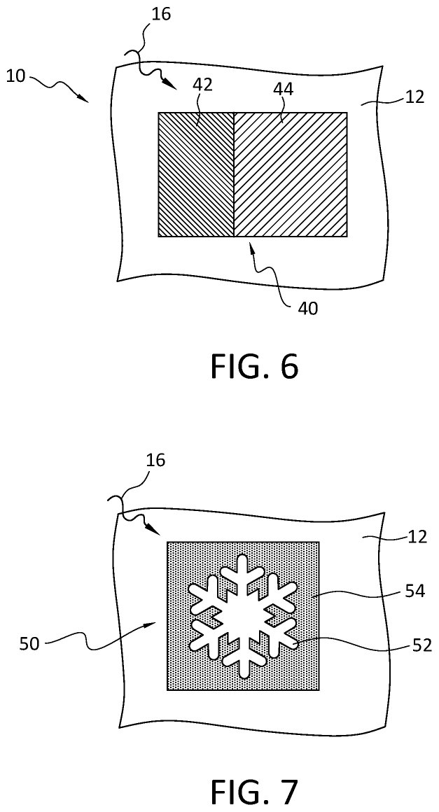

FIGS. 6 and 7 show, by way of illustration, two working examples of inventive articles provided with the luminescent printing ink described. FIG. 6 shows a detail of a banknote 10 with a paper substrate 12 and a luminescent security element 14 printed on the paper substrate and having two subregions 42, 44, each printed with a luminescent printing ink of the type described above.

The visual impression of the security element 40 when viewed under white light is not the main emphasis in the present invention. The security element may be invisible in white light or may appear as a homogeneous, single-color area, for example in that the luminescent printing inks of the subregions 42, 44, in addition to the capsule luminescence pigments described, have been admixed with suitable reflectance pigments.

On excitation with nonvisible excitation light, for example UV light 16, the security element 40 luminesces and shows a multicolor luminescence motif with different luminescence color impressions in subregions 42, 44. For example, the luminescence motif may show a national flag with a subregion 42 that luminesces in the green under UV illumination 16, and a red-luminescing subregion 44.

The green-luminescing subregion 42 may have been printed, for example, with a printing ink based on the above-described mixed ink A₁B₂ from working example 1, and the red-luminescing subregion 44 may have been printed with a printing ink based on the above-described mixed ink E₁F₂ from working example 3. The security element 40 after the excitation in the two subregions 42, 44 shows both high visual luminescence brightness and high phosphorescence intensity for machine authenticity testing.

It is also possible that just one of the subregions has been printed with a luminescent printing ink of the invention and that the other subregion has been printed, for example, with a printing ink of high visual brightness but without machine readability. Both subregions are then involved in visual authenticity testing, whereas only the subregion printed with the luminescent printing ink of the invention is involved in machine authenticity testing.

It will be apparent that it is also possible to introduce other fluorescent substances and other phosphorescent substances into the cores of the capsule pigments in order to create desired color impressions in luminescence.

FIG. 7 shows, as a further working example, a security element 50 on a paper substrate 12 of a document of value, which, on excitation with UV light 16, shows a nature motif, specifically a white snowflake 52 against a blue-sky background 54. In white light, the security element may be invisible or appear as a homogeneous, single-color area.

White luminescence of subregion 52 is obtained by suitable mixing of red-, green- and blue-luminescing capsule luminescence pigments in a printing ink that have the same stability to environmental influences, such that there is no change in the white color impression over time.

Specifically, in the working example, capsule luminescence pigments used for red and blue luminescence are those wherein red- or blue-fluorescing luminescent substances have been incorporated in the cores thereof. Red or blue phosphorescent substances are not present in the printing ink for the white subregion. For green luminescence, the printing ink contains, for example, the green-fluorescing capsule luminescence pigment GF1 and the green-phosphorescing capsule luminescence pigments GP1 of working example 1.

On UV excitation 16, the security element 50 visually shows the nature motif with a white snowflake 52 against a blue-sky background 54, as illustrated in FIG. 7. With the switching-off of the excitation radiation, there is an end to the fluorescence emission of the red and blue capsule luminescence pigments and of the green-fluorescing capsule luminescence pigment GF1.

For machine authenticity testing, the slower-decaying phosphorescence emission of pigment GP1 is used, for which it is possible to use either the decay time or the luminescence spectrum of the pigments in the green or the shape of the outline of the green-phosphorescent subregion 52 as authenticity feature.

1.-19. (canceled)

20. A luminescent printing ink for security printing, comprising a fluorescent substance and a phosphorescent substance, each of which luminesce in the visible spectral region on excitation with nonvisible excitation light, wherein
the printing ink comprises one or more capsule luminescence pigment types, each of which has a core, a shell encapsulating the core, and a luminescent substance present within the core,
the fluorescent substance and the phosphorescent substance are each present as luminescent substance in the core of one or more of the capsule luminescence pigment types, such that the capsule luminescence pigments form fluorescent and/or phosphorescent capsule luminescence pigments having fluorescence and phosphorescence,
the fluorescence and the phosphorescence have the same lightfastness,
the fluorescence and the phosphorescence have the same chemical stability, and
the fluorescence and the phosphorescence have an essentially corresponding color impression in visual terms.

21. The luminescent printing ink according to claim 20, wherein the phosphorescent substance has a greater luminescent decay time at least by a factor of 10 than the fluorescent substance, in that the phosphorescent substance has a luminescence decay time of at least 10 μs, and/or in that the fluorescent substance has a luminescence decay time below 1 μs.

22. The luminescent printing ink according to claim 20, wherein the phosphorescent substance is an organic or metal-organic phosphorescent substance and/or in that the fluorescent substance is an organic or metal-organic fluorescent substance, in that the phosphorescent substance is a metal-organic phosphorescent substance and the fluorescent substance is simultaneously an organic fluorescent substance.

23. The luminescent printing ink according to claim 20, wherein the fluorescent substance and the phosphorescent substance have different luminescence spectra.

24. The luminescent printing ink according to claim 20, wherein the fluorescent substance and the phosphorescent substance have luminescence in the green spectral region.

25. The luminescent printing ink according to claim 20, wherein the core and the shell of the various capsule luminescence pigment types each consist of the same materials, where the core of the capsule luminescence pigments consists of a first polymer and the shell of the capsule luminescence pigments of a second polymer that differs from the core polymer in at least one monomer.

26. The luminescent printing ink according to claim 20, wherein the fluorescence and phosphorescence intensities normalized to the starting value, each at 1 to 4 on the wool scale, differ from one another by fewer than 20 percentage points, by fewer than 10 percentage points.

27. The luminescent printing ink according to claim 20, wherein the color loci of the fluorescence and phosphorescence in the CIE standard color space are in the same or adjoining Kelly color regions.

28. The luminescent printing ink according to claim 20, wherein the phosphorescent substance and the fluorescent substance are each introduced separately into the cores of different capsule luminescence pigments such that the printing ink contains a first fluorescent capsule luminescence pigment type
wherein the cores contain solely fluorescent substances but no phosphorescent substances, and a second phosphorescent capsule luminescence pigment type
wherein the cores contain solely phosphorescent substances but no fluorescent substances.

29. The luminescent printing ink according to claim 20, wherein the phosphorescent substance and the fluorescent substance are each introduced separately into the cores of different capsule luminescence pigments such that the printing ink contains a first fluorescent capsule luminescence pigment type and a second phosphorescent capsule luminescence pigment type, where the luminescence of the fluorescent capsule luminescence pigment type has a luminescence decay time below 1 μs, and the luminescence of the phosphorescent capsule luminescence pigment type a luminescence decay time of at least 100 μs.

30. The luminescent printing ink according to claim 20, wherein the phosphorescent substance and the fluorescent substance are collectively introduced into the cores of capsule luminescence pigments such that the printing ink contains a fluorescent and simultaneously phosphorescent capsule luminescence pigment type wherein the cores contain both fluorescent substances and phosphorescent substances.

31. The luminescent printing ink according to claim 20, wherein the fluorescent substance in the capsule luminescence pigments is present at a concentration in the printing ink that permits visual testing of the luminescence of the luminescent printing ink.

32. The luminescent printing ink according to claim 20, wherein the luminescence brightness of the printing ink is at least 100%, of the reference brightness of a green-luminescent printing ink with a ZnS:Cu standard security pigment with 10% by weight of pigmentation and equal ink weight per unit area.

33. The luminescent printing ink according to claim 20, wherein the phosphorescent substance of the capsule luminescence pigments is present in a concentration in the printing ink that permits machine testing of the luminescence of the luminescent printing ink in a banknote processing machine.

34. The luminescent printing ink according to claim 20, wherein the phosphorescence intensity of the printing ink is at least 100%, of the reference phosphorescence intensity of a green-luminescent printing ink with a ZnS:Cu standard security pigment with 10% by weight of pigmentation and equal ink weight per unit area.

35. A method of producing a luminescent printing ink for security printing according to claim 20, in which
B) a fluorescent substance and a phosphorescent substance are provided, each of which luminesce in the visible spectral region on excitation with nonvisible excitation light, and the luminescences of which create an essentially corresponding color impression in visual terms and have equal lightfastness,
E1) the fluorescent substance is introduced into the core of first capsule luminescence pigments and the phosphorescent substance is introduced into the core of second capsule luminescence pigments, where the capsule luminescence pigments each have a core and a shell that encapsulates the core, and the materials of core and shell of the capsule luminescence pigments are chosen such that the luminescences of the first and second capsule luminescence pigments have equal chemical stability, and
D) the first and second capsule luminescence pigments with the luminescent substances introduced into the core are introduced into a printing ink.

36. A method of producing a luminescent printing ink for security printing according to claim 20, in which
B) a fluorescent substance and a phosphorescent substance are provided, each of which luminesce in the visible spectral region on excitation with nonvisible excitation light, and the luminescences of which create an essentially corresponding color impression in visual terms and have equal lightfastness,
E2) the fluorescent substance and the phosphorescent substance are collectively introduced into the core of third capsule luminescence pigments having a core and a shell that encapsulates the core, and
D) the third capsule luminescence pigments with the luminescent substances introduced into the core are introduced into a printing ink.

37. An article, especially document of value, security paper or security element, having a printed-on luminescent feature comprising at least one luminescent printing ink according to claim 20.

38. A method of producing an article according to claim 36, in which a luminescent feature is printed onto the article with at least one luminescent printing ink.
